(19) United States
(12) Patent Application Publication
(10) Pub. No.: US 2010/0155544 A1
(43) Pub. Date: Jun. 24, 2010

(54) Chain With Follow-Up Rolling Assemblies

(76) Inventor: Chi-Pin CHOU, Taichung (TW)

Correspondence Address: Dr. BANGER SHIA;Patent Office of Bang Shia, 102 Lindencrest Ct., Sugar Land, TX, 77479-5201, US

(21) Appl. No.: 12/342,425

(22) Filed: Dec. 23, 2008

(51) Int. Cl. F16G 13/18

(52) U.S. Cl. 248/55

(57) ABSTRACT

A chain with follow-up rolling assemblies comprises at least one follow-up rolling assembly which can provide a rolling contact between a suspended portion and an unsuspended portion of the chain to reduce the friction resistance and reduce the resultant dust which will contaminate the working environment. In addition, the follow-up rolling assemblies can turn freely with the chain to avoid stopping the movement of chain.

### BACKGROUND OF THE INVENTION

1. Field of the Invention

The present invention relates to a chain for a linear motion processing machine; and more particularly to a chain with follow-up rolling assemblies.

2. Description of the Prior Art

Conventional linear motion processing machines are normally actuated by wires or conduits connected to external supplies, and the wires or conduits are exposed. Therefore, a chain capable of protecting the wires or conduits against the abrasion or interference was developed on the market. The usage of the chain will satisfy the requirements of high dynamic load and long service time, and such a chain is not only applicable to transmission in different environments and climate zones, but is easy to assemble and save space.

Referring to FIG. 1, when a travel exceeds the load length of the chain 10, the suspended portion of the chain 10 will naturally droop under the action of weight to make the suspended portion abut against the non-suspended portion of the chain 10 or the machine to move. As for the situations requiring dust-free environment, the dust caused by the abutting friction will affect the product quality.

Referring to FIG. 2, in order to reduce the occurrence of dust, within the travel of the chain 10 are fixed plural fixed type rolling assemblies 90. Referring to FIG. 3, if the chain 10 is excessively long, the suspended portion of the chain 10 will also rub against the non-suspended portion of the chain 10 to produce dust. In order to avoid interference with the movement of the chain, the above fixed type rolling assemblies 90 can only be disposed on the machine, as shown in FIG. 4, or else, the rolling assemblies 90 will hinder the movement of the chain 10.

The present invention has arisen to mitigate and/or obviate the afore-described disadvantages.

### SUMMARY OF THE INVENTION

The primary objective of the present invention is to provide a chain with follow-up rolling assemblies, which can utilize the rolling assemblies to reduce the friction resistance.

In order to achieve the above objective, the chain of the present invention is provided with an assembling portion on one side thereof, and at least one rolling assembly on the assembling portion.

Further analysis of the above-mentioned shows that the present invention has the chain with following advantages:

1. The follow-up rolling assemblies can move with the rubbing portions of the chain varying, no matter upward movement or downward movement both can prevent two portions of the chain from rubbing against each other.

2. The follow-up rolling assembly can turn freely with the chain without being limited by the installing position and cannot affect the movement of the chain.

### BRIEF DESCRIPTION OF THE DRAWINGS

FIG. 1 is a plane view of a conventional chain without any fixed rolling assemblies;

FIG. 2 is a first plane view of a conventional chain with fixed rolling assemblies;

FIG. 3 is a second plane view of the conventional chain with fixed rolling assemblies;

FIG. 4 is a third plane view of the conventional chain with fixed rolling assemblies;

FIG. 5 is a first plane view of a chain with follow-up rolling assemblies in accordance with the present invention;

FIG. 6 is a partial enlarged view of the chain with follow-up rolling assemblies in accordance with the present invention;

FIG. 7 is a second plane view of the chain with follow-up rolling assemblies in accordance with the present invention is provided with follow-up rolling assemblies; and

FIG. 8 is a third plane view of the chain with follow-up rolling assemblies in accordance with the present invention is provided with follow-up rolling assembles and fixed rolling assemblies.

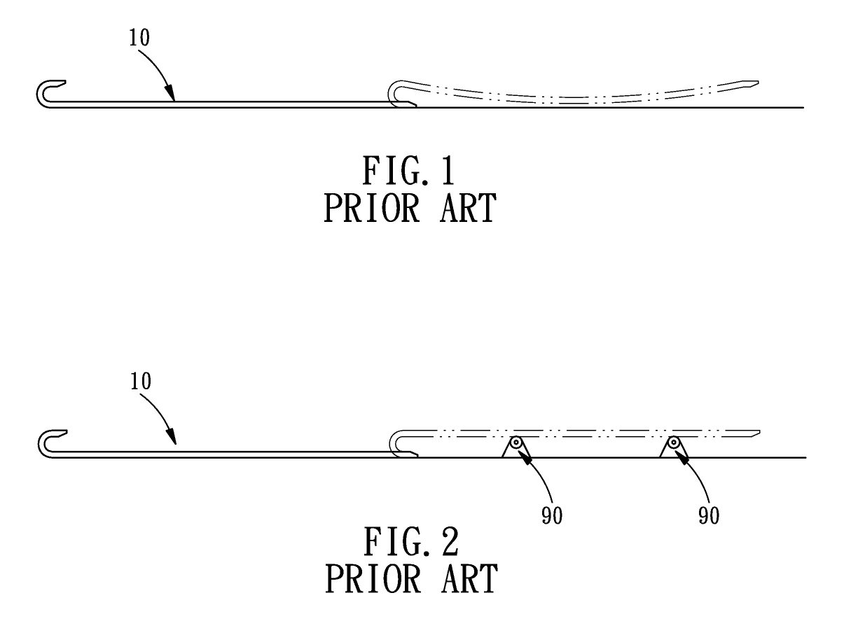

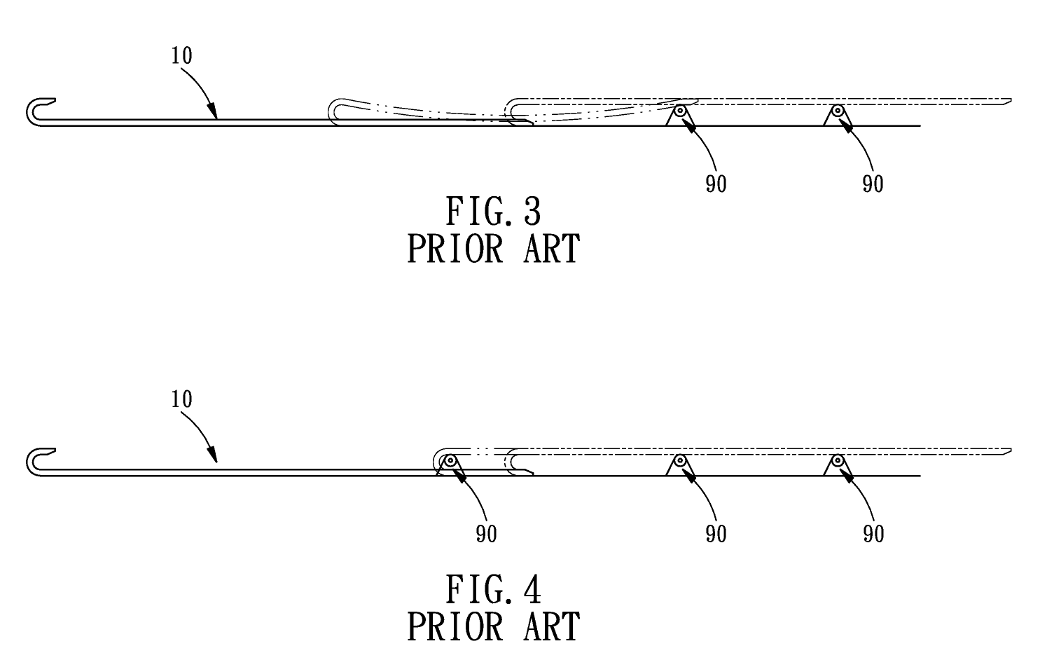

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

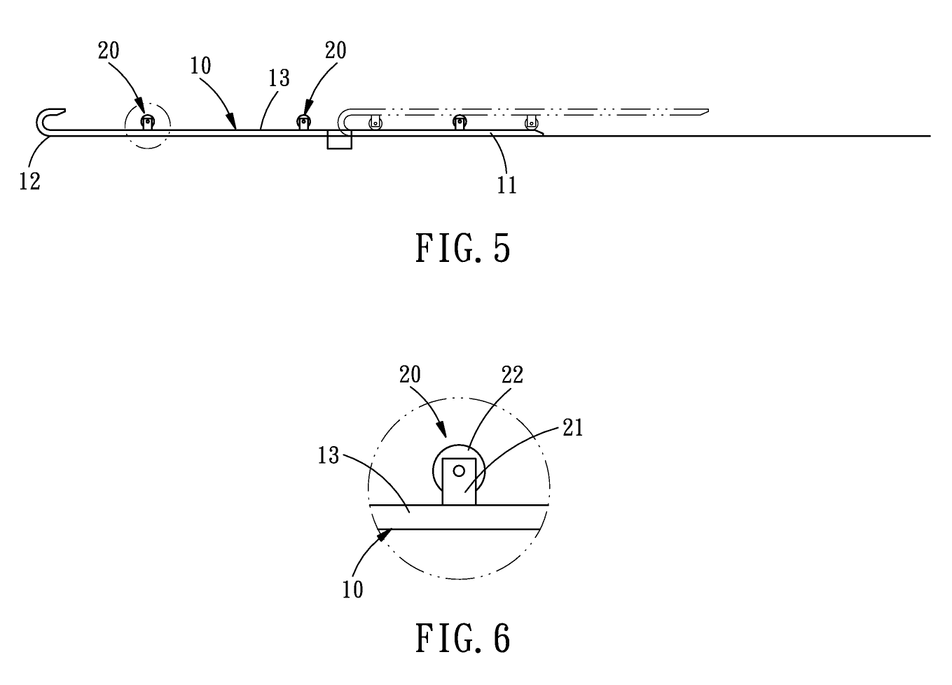

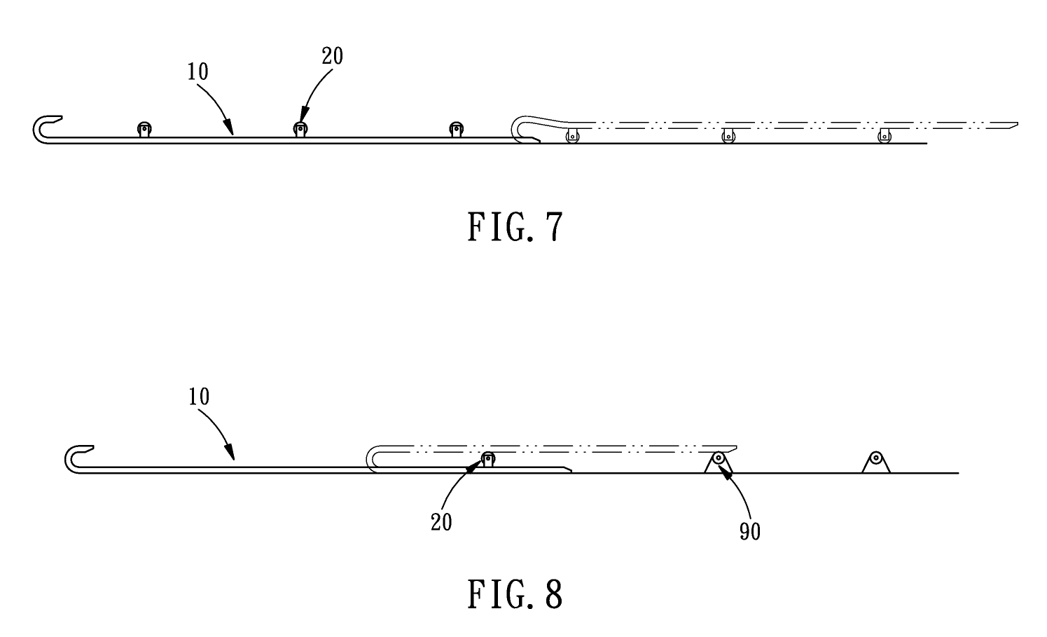

Referring to FIGS. 5-8, a chain 10 with follow-up rolling assemblies in accordance with a preferred embodiment of the present invention cooperates with a linear motion processing machine and comprises plural chain elements that are pivoted to one another in an extending direction of the chain 10. The chain 10, as shown in FIG. 5, is provided with a fixing portion 11 and a movable portion 12 at two opposite ends in the extending direction thereof. The chain 10 is further provided with an assembling portion 13 at an upper side thereof. If the fixing portion 11 is positioned, the movable portion 12 of the chain 10 will be driven to cause a bending deformation to the chain 10.

The chain 10 is provided with at least one follow-up rolling assembly 20 (as shown in FIG. 6) on the assembling portion 13. If the number of the follow-up rolling assemblies 20 is more than one, the follow-up rolling assemblies 20 will be separated from one another. The follow-up rolling assembly 20 includes a base 21 and a roller 22 pivoted on the base 21. The follow-up rolling assembly 20 is detachably assembled to the assembling portion 13 through the base 21. As shown in FIG. 5, the follow-up rolling assembly 20 is brought into rolling contact with the assembling portion 13 of the chain 10 by the roller 22, or as shown in FIG. 6, the follow-up rolling assembly 20 is brought into rolling contact with the linear motion processing machine by the roller 22.

Due to the bending deformation, the suspended portion of the chain 10 is disposed opposite to the non-suspended portion of the chain 10 in such a manner that the suspended portion and non-suspended portion of the chain 10 can be brought into rolling contact with each other by the follow-up rolling assembly 20 to reduce the friction resistance.

As shown FIG. 8, the chain 10 can be provided with a fixed rolling assembly 90 to cooperate with the follow-up rolling assembly 20 as desired.

While we have shown and described various embodiments in accordance with the present invention, it is clear to those skilled in the art that further embodiments may be made without departing from the scope of the present invention.

What is claimed is:

1. A chain with follow-up rolling assemblies comprising an assembling portion on a side thereof, and at least one follow-up rolling assembly on the assembling portion.

2. The chain with follow-up rolling assemblies as claimed in claim 1, wherein the follow-up rolling assembly includes a base and a roller pivoted on the base, the follow-up rolling assembly is detachably assembled to the assembling portion of the chain through the base of the follow-up rolling assembly and brought into rolling contact with the follow-up rolling assembly by the roller of the follow-up rolling assembly.

3. A chain with follow-up rolling assemblies, wherein the chain cooperates with a linear motion processing machine, and the chain is provided with a fixed portion and a movable portion at two opposite ends thereof, the fixed portion of the chain is fixed on the linear motion processing machine, and the movable portion of the chain is driven by the linear motion processing machine, the chain is further provided with an assembling portion on an upper side thereof, and at least one follow-up rolling assembly on the assembling portion.

4. The chain with follow-up rolling assemblies as claimed in claim 3, wherein the follow-up rolling assembly includes a base and a roller pivoted on the base, the follow-up rolling assembly is detachably assembled to the assembling portion of the chain through the base of the follow-up rolling assembly and brought into rolling contact with the assembling portion of the chain by the roller of the follow-up rolling assembly.

5. The chain with follow-up rolling assemblies as claimed in claim 3, wherein the follow-up rolling assembly includes a base and a roller pivoted on the base, the follow-up rolling assembly is detachably assembled to the assembling portion of the chain through the base of the follow-up rolling assembly and brought into rolling contact with the linear motion processing machine by the roller of the follow-up rolling assembly.
